(19) United States
(12) Patent Application Publication
(10) Pub. No.: US 2011/0199796 A1
(43) Pub. Date: Aug. 18, 2011

(54) STRUCTURE OF A POWER SUPPLY

(76) Inventors: XIN WU, SHANGHAI (CN); SHU-ZHUANG LU, SHANGHAI (CN)

(21) Appl. No.: 13/094,343

(22) Filed: Apr. 26, 2011

Related U.S. Application Data
(63) Continuation-in-part of application No. 12/200,225, filed on Aug. 28, 2008.

(51) Int. Cl. H02M 3/335

(52) U.S. Cl. 363/21.17

(57) ABSTRACT

An improved structure of a power supply is based on an emitter-switched PWM controller and special structure transformer. An improved structure of a power supply mainly describes two primary side regulation (here called “PSR”) solutions based on above PWM controller that is used in charger/adapter solutions. These PSR solutions employ a transformer with special winding structure. It is required that adjacent reeling between its input bias winding and output winding, in which the input side of the transformer is connected to an AC input and an emitter-switched PWM controller, and the output side of the transformer is connected to a rectified diode. The present invention further provides low cost PSR solutions with higher system reliability, better line/load regulation, and short circuit characteristic.

This application is a continuation-in-part, and claims priority, of from U.S. patent application Ser. No. 12/200,225 filed on Aug. 28, 2008, entitled “AN IMPROVED STRUCTURE OF A POWER SUPPLY”, the entire contents of which are hereby incorporated by reference.

### FIELD OF THE INVENTION

The present invention is related to low power charger/adapter solutions with primary side regulation that bases on emitter switched PWM controller and special transformer structure.

### BACKGROUND OF THE INVENTION

Most chargers/adapters adopt switching mode power supply (SMPS) in mobile phone and home appliance to replace linear transformer solution. The SMPS circuit usually consists of AC input, PWM controller, transformer and constant voltage/current control circuit, wherein the constant voltage/current control circuit are coupled through an optical coupling element, and the input side of the transformer is connected to the AC input and PWM controller of the charger/adapter, and the output side of the transformer is connected to the constant voltage/current control circuit and optical coupling element. All these SMPS circuits employ step-down transformer composed of primary side winding, secondary side windings and/or bias winding.

FIG. 1 is a circuit diagram which shows a kind of charger/adapter circuit in the prior architecture.

It shows a kind of common charger/adapter circuit 100. The charger/adapter circuit 100 includes an AC input section 101 and PWM controller 102, transformer 103, constant voltage control circuit 108, and constant current control circuit 109, wherein the constant voltage control circuit 108 and the constant current control circuit 109 are coupled with the AC input section 101 and PWM controller 102 through an optical coupling element 104. In the charger/adapter circuit 100, the input side of the transformer 103 has primary winding 103a and an input bias winding 103b, and the output side has an output winding 103c, wherein the first terminal of the output winding 103c is connected to the positive electrode of the diode 118, and its second terminal is connected to the current sense resistor 113. In the charger/adapter circuit 100, resistors 114 and 115 are for regulating the output voltage to achieve constant voltage, capacitor 110 are voltage compensative element, capacitor 111 are current compensative element, resistor 113 is to achieve constant current, and other accessorial electronic elements includes capacitor 117 & 119, resistor 120 & 122. It must be pointed that constant current circuit 109 and all these accessorial elements are changeable and optional.

Compared to linear transformer circuit, the charger/adapter circuit 100 employs PWM and constant voltage/current controller 102, 103, 109 to precisely adjust duty cycle when line voltage or load is changed, so system reliability, output characteristics, line and load regulation are all better than linear transformer circuit. However, the cost of SMPS circuit is about 20%˜50% higher than linear transformer circuit, so many charger/adapter makers can not satisfied with the SMPS circuit.

Therefore, it is absolutely necessary to provide new cost down solutions with less component count, small print circuit board size and better price/performance ratio.

### SUMMARY OF THE INVENTION

The present invention is to provide basic cost down solutions with primary side regulation (PSR solution) for low power charger/adapter application with higher system reliability, better line/load regulation, and short circuit characteristic.

The invention is based on a low cost PWM controller with emitter switched architecture. The current mode PWM controller contains output terminal, the VCC terminal and ground terminal. The output terminal is to produce switching pulse which can be connected with the emitter of NPN transistor or the source of MOSFET, the VCC terminal is used for both bias supply and feedback control, the ground terminal is supply ground.

The present invention provides low voltage PNP transistor and zener diode to improve the line and load regulation.

The present invention provides −431 typed shunt regulators to further improve the line and load regulation.

The present invention provides a transformer used in the charger/adapter solution, in which the tight coupling between the transformer input bias winding and output winding is also important, adjacent reeling between input bias winding and output winding is required by the invention. If the output winding and input bias winding are not adjacement, the load regulation of output voltage is not good.

The input side of the transformer is connected to an AC input and PWM control circuit, the output side of the transformer is connected to rectified diode, no need of constant current/voltage circuit, no need of an optical coupling element, so the cost of the PSR solution is lower than linear transformer solution, and it can be called low cost PSR solution.

The present invention of PSR solutions has such features as less component number, low total cost, high reliability, and better line/load regulation, so this PSR solution will be accepted by more and more charger/adapter makers.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a circuit diagram showing a kind of charger/adapter circuit in the prior architecture;

FIG. 2 is the function block of the PWM controller;

FIG. 3 is the first PSR solution based on the PWM controller;

FIG. 4 is the testing result of output characteristics of the first PSR solution;

FIG. 5 is the curve of output voltage VS line voltage of the first PSR solution;

FIG. 6 is the second PSR solution based on the PWM controller;

FIG. 7 is the third PSR solution based on the PWM controller;

FIG. 8 is the solution with the integrated transistor and PWM controller;

FIG.9 is the solution with the MOSFET and PWM controller;

FIG.10 is the transformer architecture to reduce EMI.

### DETAILED DESCRIPTION OF THE PREFERRED EMBODIMENTS

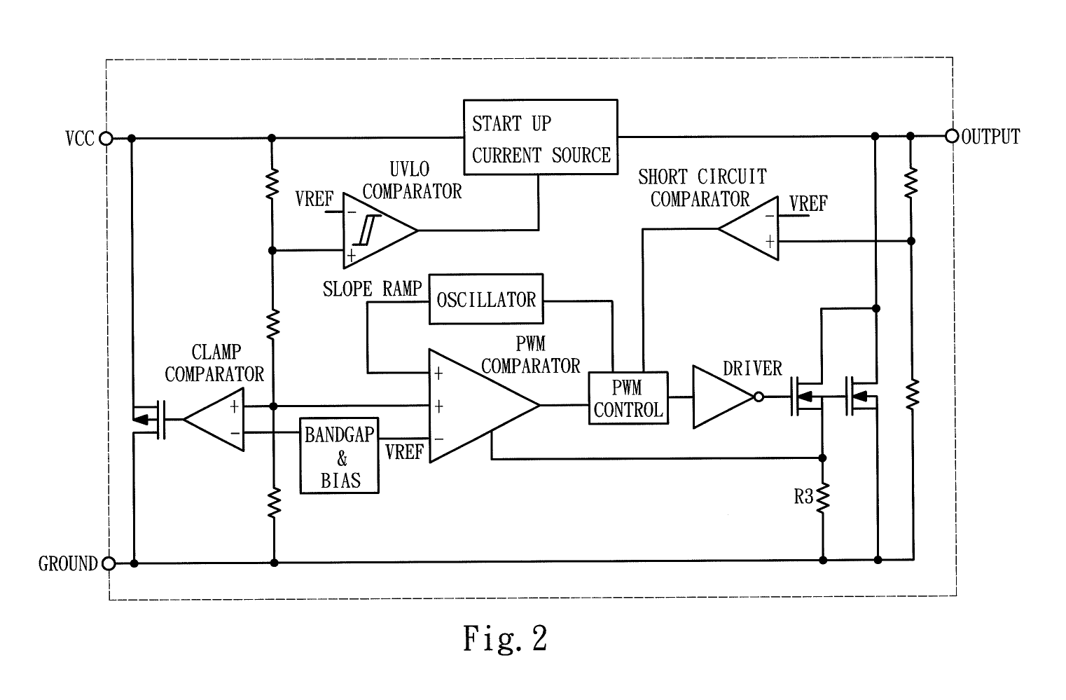

FIG. 2 is the function block of the mentioned PWM controller. Its main function circuits include: a start up current source which is connected to VCC and determines the interim threshold duty voltage of VCC at the power on stage and the minimum duty voltage during normal operation;

an oscillator which generates a square wave signal at a constant frequency and has an output end connecting to a PWM control and a positive and negative temperature compensation circuit to generate the constant frequency used by the power supply;

a clamp comparator which has an input end connecting to VCC in response to a current sampling signal of an driver to carry out feedback of a current circuit. The clamp comparator also responds to voltage variations of VCC to carry out feedback of a voltage circuit. Current feedback signals and voltage feedback signals are sent to the PWM control in an error signal format through the clamp comparator;

the PWM control which is connected to the oscillator to respond to the square wave signal output therefrom and also is connected to the clamp comparator to receive the error signal thereof to determine the duty cycle of output driving pulse. The PWM control further responds to input signals of a short circuit comparator and periodically stops output signals to protect the system;

the short circuit comparator which has one input end connecting to VCC and another input end connecting to an output end of the driver. During normal operation the voltage of the output end of the driver is higher and the voltage of VCC is lower. In the event of short circuit or a light loading condition and the output end voltage of the output driver is lower, the voltage of VCC is higher, the short circuit comparator makes the PWM controller to enter a short circuit protection mode; and

the driver which has an input end connecting to the PWM control and output ends connecting to the short circuit comparator and the clamp comparator to output the PWM pulse signals. It is connected to and drives a power transistor outside the PWM pulse controller through power elements located inside the PWM controller.

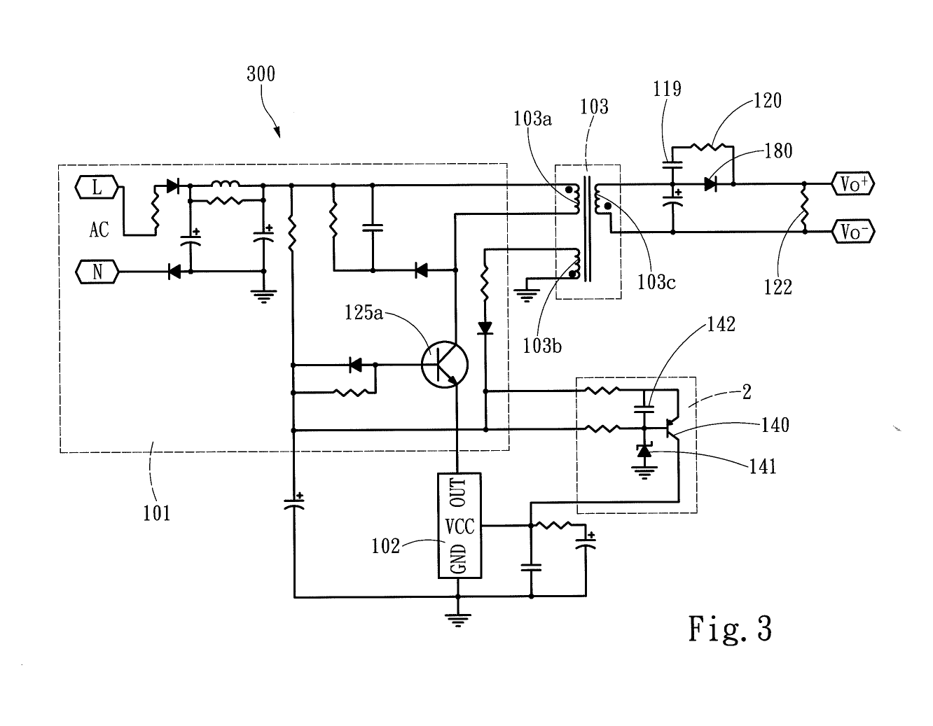

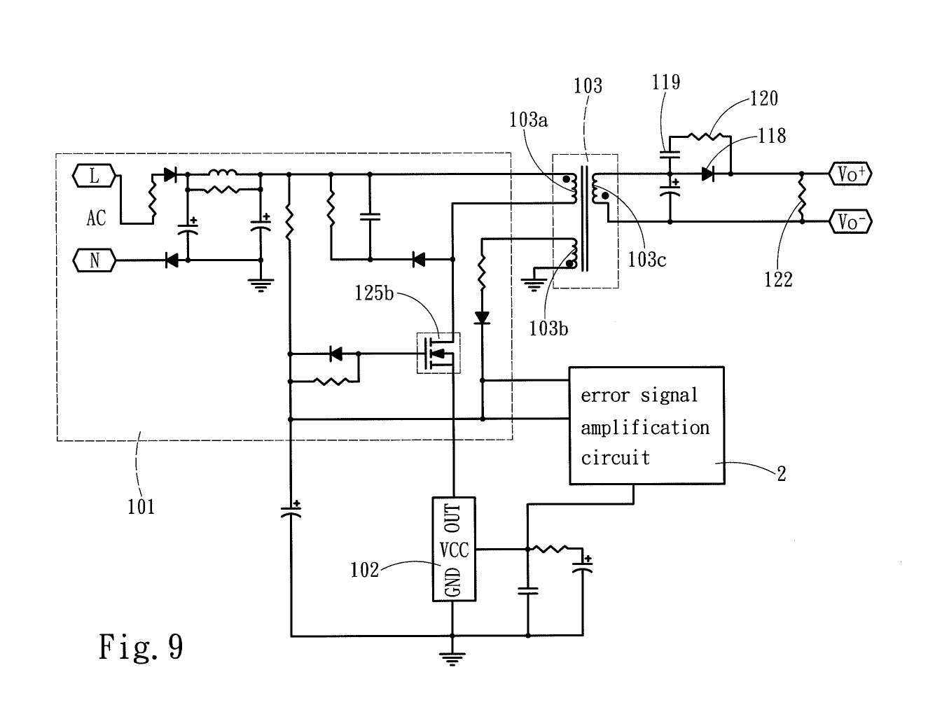

The current mode PWM controller contains output terminal, the VCC terminal and ground terminal. The output terminal is to produce switching pulse which can be connected with the emitter of NPN transistor 125a (as shown in FIG. 3) or the source of MOSFET 125b (as shown in FIG. 9), the VCC terminal is used for both bias supply and feedback control, the ground terminal is supply ground. When the PWM controller is powered on, the startup current source (or called regulators) turns on and can not turns off until VCC level rises up to its threshold value and PWM pulse is produced. The external inductor current through the output terminal is converted to a voltage by an internal resistor R3, and this voltage will participate to control duty cycle and peak inductor current.

FIG. 3 is application schematics of the first PSR solution circuit in a preferred embodiment according to the present invention. It should be noticed that, although FIG. 3 shows the practical application of the charger/adapter solution, the transformer and the charger/adapter solution are simultaneously explained in the description of FIG. 3.

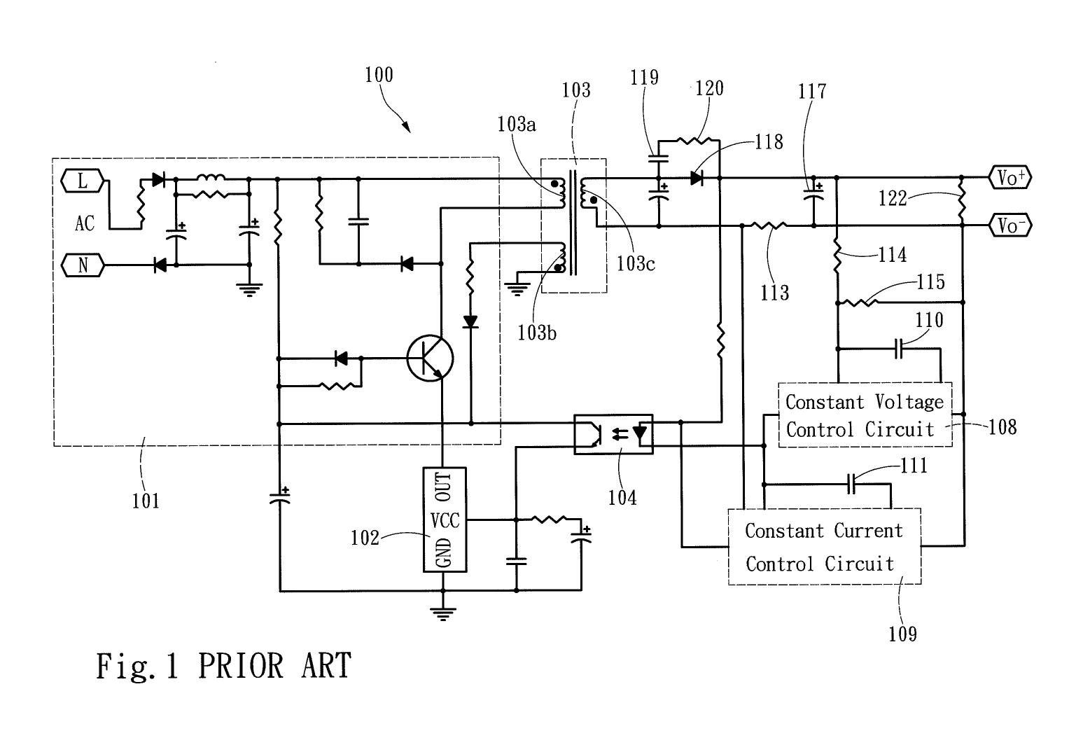

Please refer to FIG. 3, comparing FIG. 3 with FIG. 1, the circuit 300 adopts an error signal amplification circuit 2 to substitute the constant voltage control circuit 108 and/or the constant current control circuit 109. Therefore, it is no need of constant voltage/constant current circuit, optical coupling element or several accessorial elements any more. In the error signal amplification circuit 2, zener diode 141 and capacitor 142 form error signal, low voltage transistor 140 will amplify the error signal, so the PWM controller 102 can response load/line variation better to improve line/load regulation. The transformer 103 is also a key component that will influence short circuit characteristics, load and line regulation. The tight coupling between windings 103b and 103c is also important.

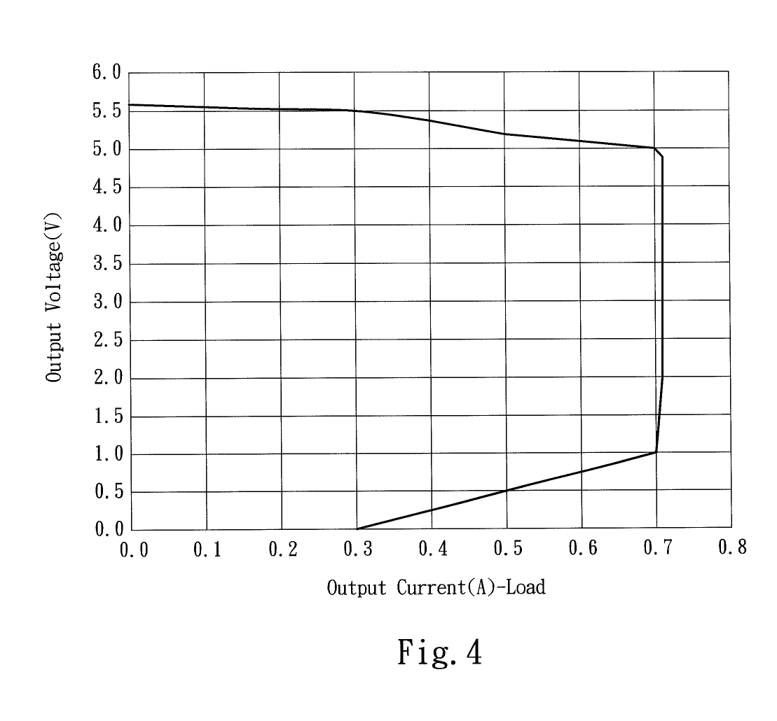

Generally, the first PSR solution for charger/adapter application according to the present invention can meet the requirement of low cost, significantly improve output characteristics, line and load regulation. The test result shows that ±5% load regulation and ±2% line regulation is obtainable in an application of 5.2V/0.7 A adapter/charger. FIG. 4 is the output characteristics under 110V AC input, and it can be seen that the variation of the output voltage is 0.53V when the output current is from 0.7 A to 0 A, so the load regulation is ±5%.

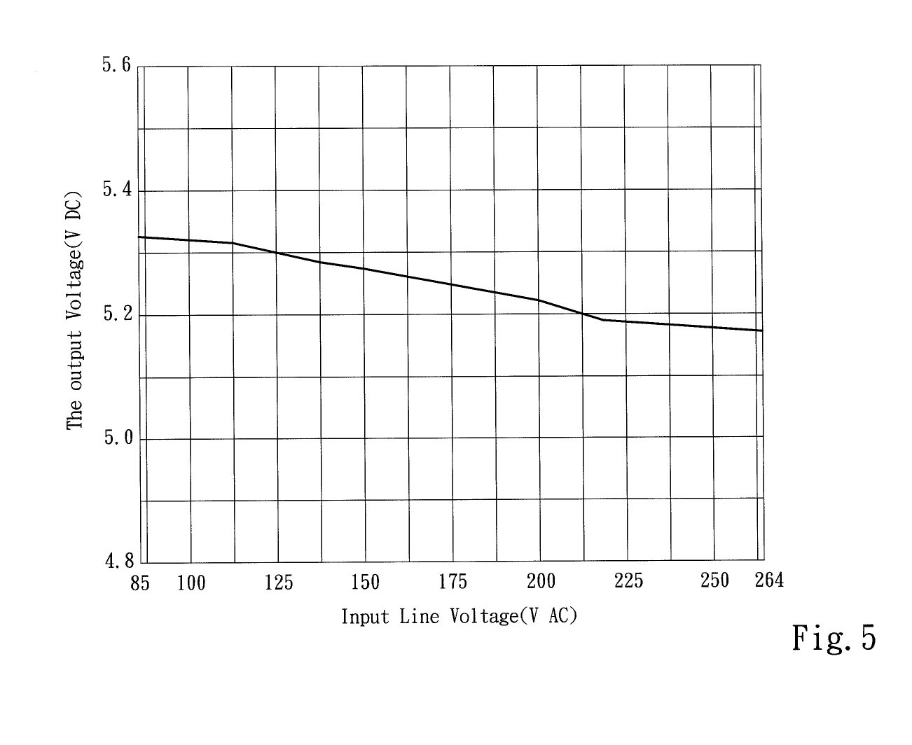

FIG. 5 gives the variation of the output voltage vs. input line voltage. When line voltage is from 85V AC to 264V AC, the output voltage is from 5.338V to 5.164V DC, so line regulation is ±1.5%.

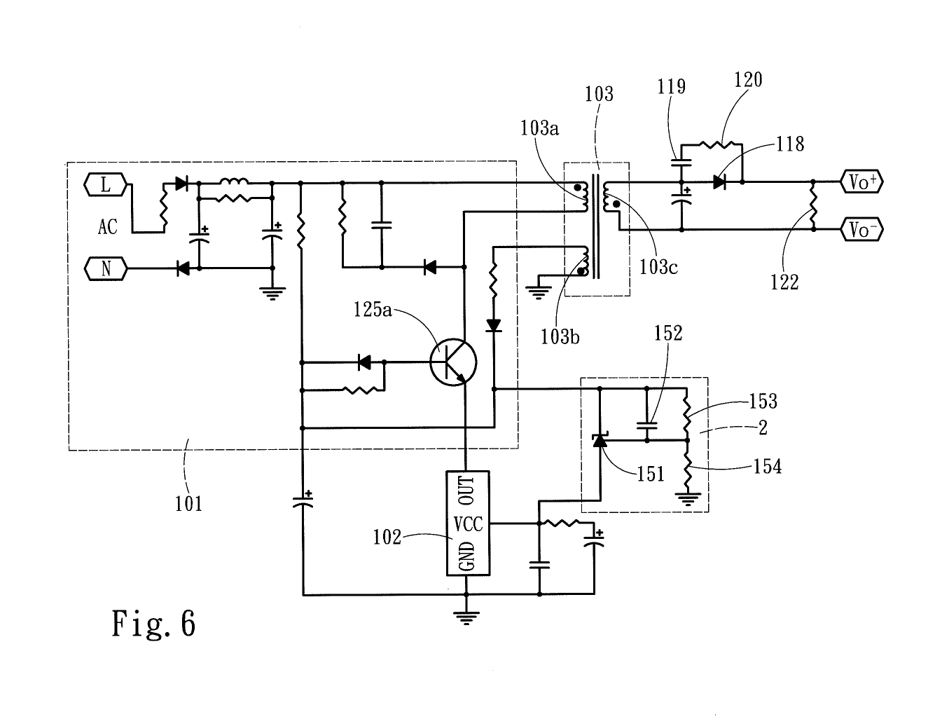

FIG. 6 is the second PSR solution for charger/adapter circuit, the error signal amplification circuit 2 is composed of −431 typed shunt regulators 151, resistor 153/154 to regulate the output voltage, and phase/gain compensation capacitor 152. Shunt regulators 151 can sense and amplify the input error signal caused by the changes of load or line voltage, so the precision of line/load regulation is good as the first PSR solution.

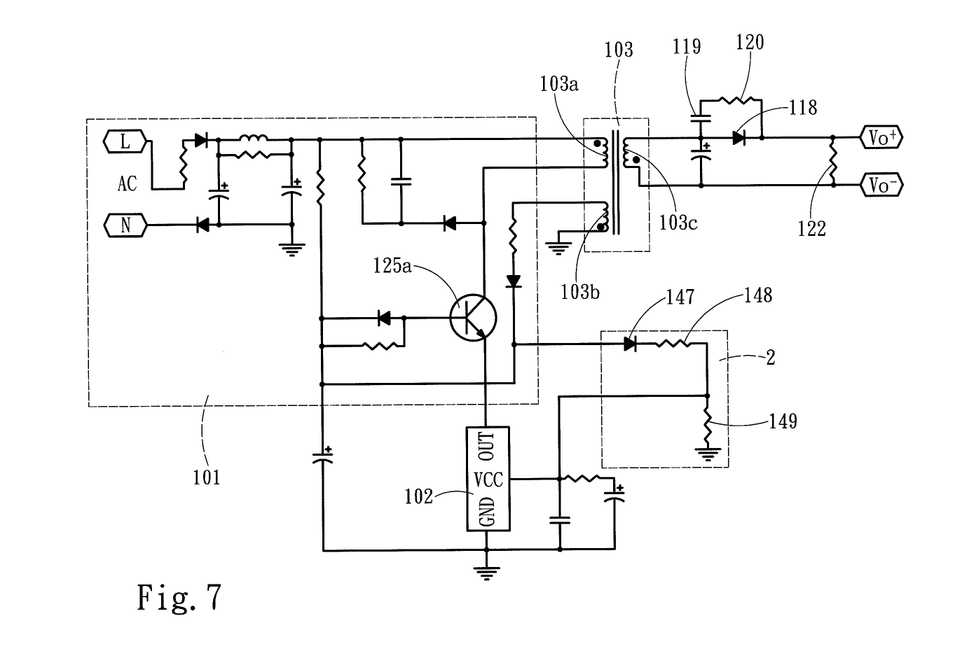

FIG. 7 is the third PSR solution for charger/adapter application, error signal amplification circuit 2, diode 147 and resistor 148/149 form sense circuit of error signal, but there is no signal amplification circuit, so the precision of line/load regulation is not as good as the first PSR solution.

The second and third PSR solutions adopt the same transformer process as the first PSR solution.

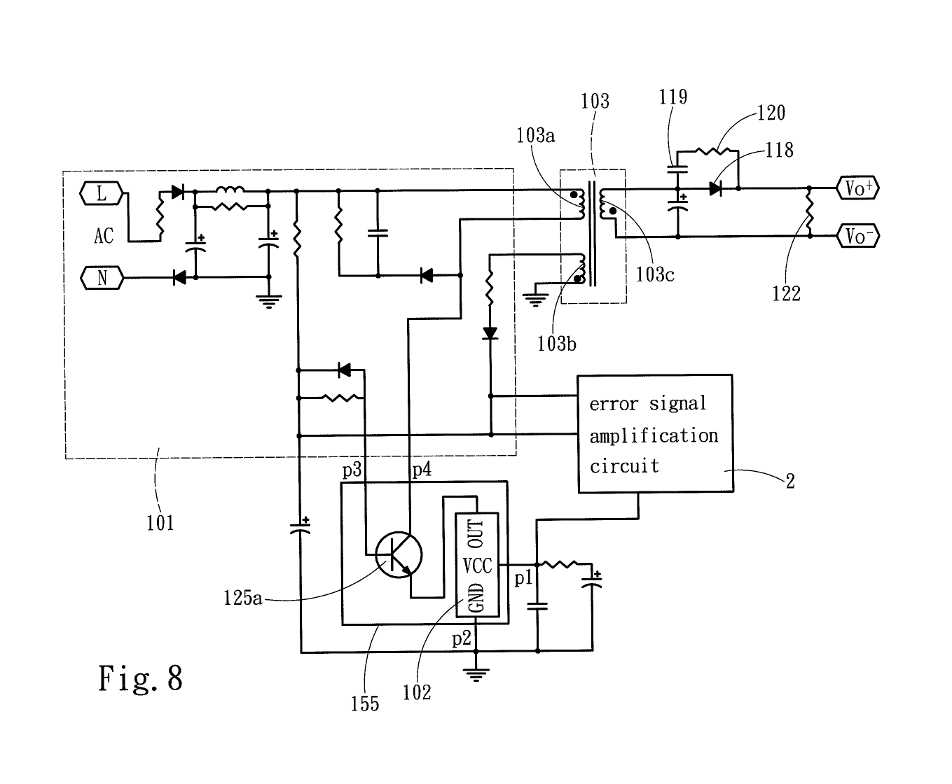

FIG. 8 is the solution with the integrated transistor and PWM controller, the integrated circuit 155 has four terminals p1, p2, p3 and p4.

FIG. 9 is the solution with the MOSFET 125b and PWM controller, the shortage of the solution is higher cost of MOSFET.

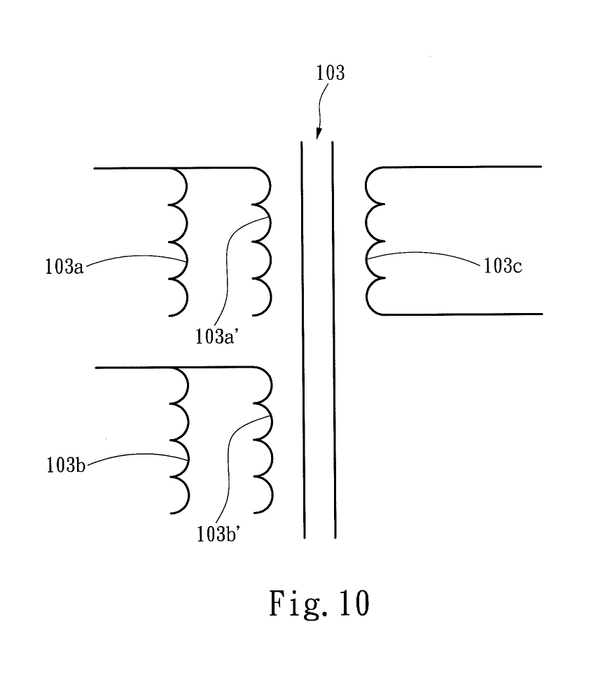

FIG. 10 is the actual transformer of the invention to replace transformer 103. Winding 103a′ is shield winding reeled with primary winding 103a. Winding 103b′ is shield winding reeled with bias winding 103b. One shield winding that reeled with primary winding is inside of primary winding, another shield winding that reeled with bias winding is outside of bias winding. The transformer structure can enhance coupling between primary side winding and secondary side winding, meanwhile these two shield windings can reduce EMI.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An improved structure of a power supply applied to a switching mode power supply, the switching mode power supply comprising:
an AC input section;
a PWM controller which has a start up current source connected to VCC to determine the interim threshold duty voltage of VCC at the power on stage and the minimum duty voltage during normal operation, and a clamp comparator connected to VCC in response to a current sampling signal of an driver to carry out feedback of a current circuit; wherein the clamp comparator responds to voltage variations of VCC to carry out feedback of a voltage circuit, and sends current feedback signals and voltage feedback signals to a PWM control in an error signal format; wherein the PWM control is connected to an oscillator to respond to the square wave signal output therefrom and is connected to the clamp comparator to receive the error signal thereof to determine the duty cycle of output driving pulse, the PWM control responding to input signals of a short circuit comparator and periodically stopping outputting signals to protect the system; wherein the short circuit comparator has one input end connecting to VCC and another input end connecting to an output end of the driver; during normal operation, the voltage of the output end of the driver being higher and the voltage of VCC being lower; in the event of short circuit or a light loading condition and the output end voltage of the output driver being lower, the voltage of VCC being higher, and the short circuit comparator making the PWM controller to enter a short circuit protection mode; wherein the driver has an input end connecting to the PWM control and output ends connecting to the short circuit comparator and the clamp comparator to output the PWM pulse signals, the driver being connected to and driving a power transistor outside the PWM pulse controller through power elements located inside the PWM controller; and
a transformer and constant voltage/current circuit,
wherein an error signal amplification circuit is connected to the AC input section and the PWM controller and the error signal amplification circuit forms an error signal so that the PWM controller can response load/line variation better to improve load/line regulation.

2. The improved structure of a power supply as claimed in claim 1, wherein the current mode PWM controller contains output terminal, the VCC terminal and ground terminal, the output terminal producing switching pulse which is connected with the emitter of NPN transistor or the source of MOSFET, the VCC terminal being used for both bias supply and feedback control, the ground terminal being a supply ground.

3. The improved structure of a power supply as claimed in claim 1, wherein the error signal amplification circuit is composed of shunt regulators to sense and amplifies the input error signal caused by the changes of load or line voltage.

4. The improved structure of a power supply as claimed in claim 1, wherein the error signal amplification circuit is composed of a diode and two resistors to form sense circuit of error signal.

5. The improved structure of a power supply as claimed in claim 1, wherein the transformer has two shield windings, one shield winding reeled with primary winding being inside of the primary winding, another shield winding reeled with bias winding being outside of the bias winding; coupling between the primary side winding and the secondary side winding being enhanced through the transformer structure to reduce EMI.
